(19) United States
(12) Patent Application Publication
(10) Pub. No.: US 2009/0233601 A1
(43) Pub. Date: Sep. 17, 2009

(54) METHOD AND SYSTEM FOR IMPROVED HANDOVER OF MOBILE STATIONS OUT OF UNLICENSED MOBILE ACCESS NETWORKS

(76) Inventors: Jari Tapio Vikberg, Jarna (SE); Tomas Nylander, Varmdo (SE)

Correspondence Address: ERICSSON INC., 6300 LEGACY DRIVE, M/S EVR 1-C-11, PLANO, TX, 75024, US

(21) Appl. No.: 11/720,867

(22) PCT Filed: Dec. 8, 2004
(86) PCT No.: PCT/IB04/04041

§ 371 Date: Jun. 5, 2007

(51) Int. Cl. H04W 36/00

(52) U.S. Cl. 455/436

(57) ABSTRACT

The present invention provides a system and various methods for handover of a mobile station (MS) (300) out of an unlicensed mobile access network (UMAN). More specifically, the present invention provides a method for handover of a mobile station (MS) (300) out of an unlicensed mobile access network (UMAN) by receiving (402) a URR Handover Required message (312) containing one or more MS Target Cell Identifiers, selecting (404) one of the MS Target Cell Identifiers based on one or more UNC criteria, and sending a Handover Required message (314) containing the selected Target Cell Identifier The one or more UNC criteria comprise MS Priority, MS Registration Information, MS User Information, UNC Priority, UNC Static Target Cell List, UNC Dynamic Target Cell List, Operator Policies or Rules, Excluded Target Cell List (Black List), AP Based Target Cell List, Network Conditions, or any combination thereof.

### FIELD OF INVENTION

The present invention relates in general to the field of mobile communications and, more particularly, to a method and system for improved handover of mobile stations out of unlicensed mobile access networks.

### BACKGROUND ART

In any mobile communication system, such as a Global System for Mobile communications (GSM) network, active calls conducted between a mobile station (MS) and a base station need to be handed over to a different base station as the mobile station moves between different coverage areas, or cells. Depending on how each cell is defined, handover may require the active call to be re-routed simply through a different base station transceiver (BTS), through a different base station controller (BSC) or through a different mobile services switching center (MSC). Handover may also be necessary when capacity problems are met in any one cell.

Handover necessitates a certain amount of operation and maintenance activities on installation of a system, such as defining neighboring cells, as well as the BSC and MSC that controls the cell, defining which cell frequencies should be measured and what threshold value to use to initiate handover. In a conventional GSM network the BSC sends a MS a list of predetermined frequencies to be measured. Two lists may be sent out, a first list being used for idle mode, such as when the MS is roaming, and a second used for active mode when a call is ongoing. This second list defines which frequencies the MS should measure and report back on. These lists contain a set of values that refer to absolute radio frequency channel numbers (ARFCN) of neighboring cells. In addition to these frequency channel numbers, the BSC also knows base station identity codes (BSIC) of all neighbouring cells. The MS measures the frequencies defined by these channel numbers and reports these measurements to the BSC. In practice, the MS will report on only the six best measurement values and only for those cell frequencies with which the MS can synchronize and consequently receive a BSIC. The measurement report sent back to the BSC by the MS includes a reference to the ARFCN, the BSIC and an indication of the received downlink signal strength. In fact the report does not specify the exact ARFCN but rather refers to the position this number occupied in the measurement list. On the basis of this report, the BSC decides whether handover is necessary and to which cell. The initiation of handover is performed according to the standard GSM mechanism for each vendor. Specifically, a message is sent by the base station controller to the MSC connected to the BSC indicating that handover is required. This message contains a cell identifier, encompassed in a cell global identity (CGI), which defines the mobile country code, mobile network code, location area code and cell identifier for the cell to which handover is requested. The CGI is fetched by the BSC from a list using the BSIC and ARFCN obtained for the cell. With this CGI the MSC is able to determine which other MSC handles the cell defined by the CGI value.

Recently proposals have been made to extend conventional cellular networks by including access networks that utilize a low power unlicensed-radio interface to communicate with MSs. The unlicensed mobile access (UMA) networks (UMANs) are designed to be used together with the core elements of a standard public mobile network and consist essentially of plug-in low-power unlicensed radio transceivers, or access points (AP), each AP designed to establish an unlicensed radio link with a MS and a controller or interface node connecting the unlicensed radio transceivers with the mobile core network. Suitable unlicensed-radio formats include digital enhanced cordless telecommunications (DECT), wireless local area network (WLAN) and Bluetooth. An adapted mobile handset capable of operating over both the standard air interface (e.g., the Um interface) and the unlicensed-radio interface means that the subscriber requires only one phone for all environments. The UMA network is constructed so that the core elements, such as the MSCs, of the public mobile network views the interface node as a conventional BSC. Such a UMA network and the MS for use with this UMA network are described in various UMA standard specifications and other implementations, such as European patent application No. EP-A-1 207 708. The content of this application is incorporated herein by reference.

The low power and resultant low range of the unlicensed-radio interface means that several such UMA networks may be provided in relatively close proximity, for example one access network per floor of an office building or in a private home. The connection between the unlicensed-radio transceivers and the associated unlicensed network controller (UNC) is provided by a fixed broadband network. Preferably, communication over this network uses the internet protocol (IP), which greatly facilitates the installation of the UMA network, permitting a subscriber to plug-in an unlicensed-radio transceiver or in his own home and consequently install an unlicensed-radio access point (AP) himself. However, the flexibility of such UMA networks also presents difficulties. Since an access point can be freely installed and moved by a subscriber to a separate city, state or even country, yet still connect to its original UNC, the exact location of the AP cannot always be tracked by the core network. Massive cell planning by the operator is required for the core network to track the location of the AP. This imposes huge demands on the operation and maintenance activities required for handover to and from the UMA network, as neighboring cells may change frequently. Also billing restraints in some areas may require the re-assignment of a relocated AP to a more appropriate UNC, particularly if revenue from calls originating from a specific AP must be accounted for in a specific region of a country. In view of the small size of the AP to an UMA network, it would not be cost effective for operators to configure each AP separately. However, it is also undesirable to leave the task of configuration to the subscriber as such a solution would be error prone and consequently unreliable. In addition, suppliers would not wish to configure AP differently depending on where these are ultimately to be installed.

Moreover, current Unlicensed Mobile Access (UMA) specifications provide that the MS makes the decision on when handover out from UMAN should be triggered based on following information: (1) local measurements of UMA coverage signal quality; (2) reception of a URR Uplink Quality Indication message from the UNC indicating poor uplink quality; (3) reception of RTCP packets indicating poor uplink quality; and (4) excessive loss or delay in the received RTP packets. Furthermore, it is the responsibility of the MS to provide the Handover Target Cell(s) (as CGIs) to the UNC. The UNC then initiates the handover towards those cell(s) using the Cell information provided by the MS. Typically, the MS sends a URR Handover Required message to the UNC that contains a list of one or more GSM CGIs. The MS prioritizes these CGI's in the order of preference meaning that the most suitable GSM cell is included as the first CGI (most suitable as detected and decided by the MS). When UNC receives this message, it initiates the normal A-interface procedures towards the Core network to initiate handover out of the UMAN. As a result, the UNC and the operators rely totally on the MS to provide a correct GSM Cell Identity as the Handover Target cell. This means that the MS could repeatedly trigger handover to a GSM Cell without ever succeeding. Furthermore, the network operator has no way of controlling the preferred Handover Target Cells from UMAN.

### SUMMARY OF THE INVENTION

The present invention provides a method and system for improved handover of mobile stations (MS) out of unlicensed mobile access networks (UMAN) that allows the UMAN operator some freedom in the selection of a Handover Target Cell. The selection of the Handover Target Cell can be based on one or more UNC criteria that may include MS Priority, MS Registration Information, MS User Information, UNC Priority, UNC Static Target Cell List, UNC Dynamic Target Cell List, Operator Policies or Rules, Excluded Target Cell List (Black List), AP Based Target Cell List, Network Conditions, or any combination thereof. As a result, the UMAN operator can devise and implement Target Cell selection criteria that are simple or complex, static or dynamic, manual or automatic, intuitive or adaptive, etc. In other words, the UMAN operator controls MS handover out of its network.

More specifically, the present invention provides a method for handover of a mobile station (MS) out of an unlicensed mobile access network (UMAN) by receiving a URR Handover Required message containing one or more MS Target Cell Identifiers, selecting one of the MS Target Cell Identifiers based on one or more UNC criteria, and sending a Handover Required message containing the selected Target Cell Identifier. A second Handover Required message containing a next selected Target Cell Identifier can be sent whenever the handover fails.

The present invention also provides a system in an unlicensed mobile access network (UMAN) that includes a mobile station (MS), an unlicensed mobile access network controller (UNC) in communication with the MS, and one or more UNC databases accessible by the UNC and containing one or more UNC criteria used to select a Target Cell Identifier for a handover of the MS out of the UMAN.

The MS Target Cell Identifiers may comprise a prioritized list of GSM CGIs. In addition, a UNC Target Cell Identifier can be selected instead of one of the MS Target Cell Identifiers. Likewise, the one or more UNC criteria may comprise one or more UNC (302) maintained Handover Target Cell Lists, a UNC maintained Handover Target Cell List for each MS or AP based on information provided by the MS to the UNC during registration, or a UNC maintained Handover Target Cell List that is dynamically based on how handovers out from UMAN are succeeding or failing. Note that all methods described herein can be performed by a computer program embodied on a computer readable medium wherein each step is implemented by one or more code segments.

### BRIEF DESCRIPTION OF THE DRAWINGS

Further benefits and advantages of the present invention will become more apparent from the following description of various embodiments that are given by way of example with reference to the accompanying drawings:

FIG. 1 is a block diagram depicting parts of a GSM network with a UMA network in accordance with the present invention;

FIG. 2 is a block diagram of the UMA high level functional architecture;

FIGS. 3A and 3B depict representative signaling sequences for the handover of a MS out of UMAN;

FIG. 4 is a flow chart depicting the handover of mobile stations (MS) out of unlicensed mobile access networks (UMAN) in accordance with the present invention; and

FIG. 5 depicts an example of representative signaling sequences using a handover procedure in accordance with one embodiment of the present invention.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a method and system for improved handover of mobile stations (MS) out of unlicensed mobile access networks (UMAN) that allows the UMAN operator some freedom in the selection of a Handover Target Cell. The selection of the Handover Target Cell can be based on one or more UNC criteria that may include MS Priority, MS Registration Information, MS User Information, UNC Priority, UNC Static Target Cell List, UNC Dynamic Target Cell List, Operator Policies or Rules, Excluded Target Cell List (Black List), AP Based Target Cell List, Network Conditions, or any combination thereof. As a result, the UMAN operator can devise and implement Target Cell selection criteria that are simple or complex, static or dynamic, manual or automatic, intuitive or adaptive, etc. In other words, the UMAN operator controls MS handover out of its network.

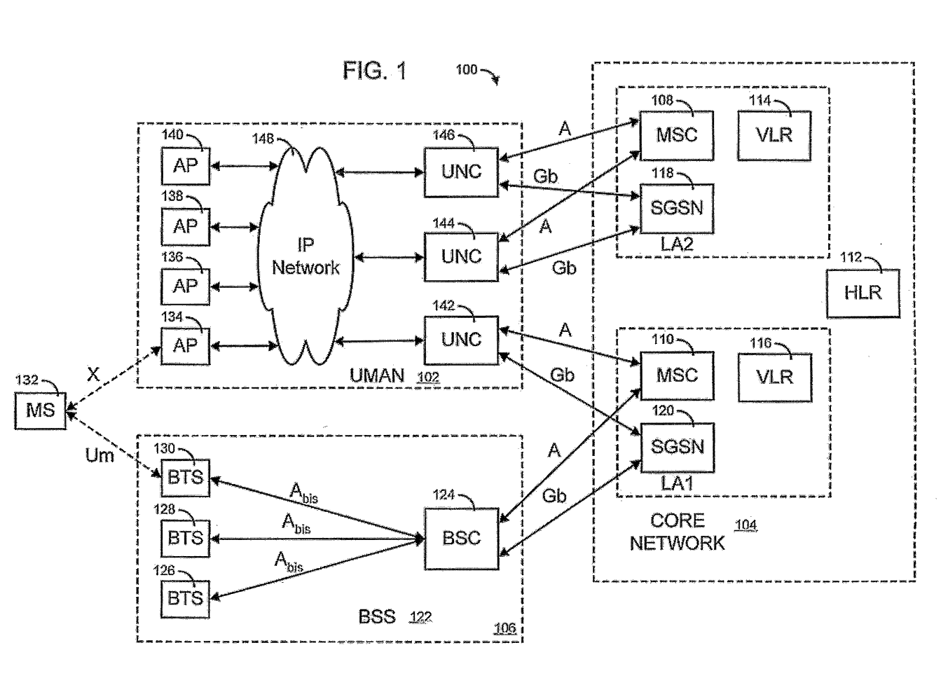

Referring now to FIG. 1, a block diagram depicting parts of a GSM network 100 with a UMA network 102, which is one type of access portion 106, in accordance with the present invention is shown. The GSM network 100 is essentially divided into a core network portion 104 and an access portion 106. The elements of the core network 104 include the mobile switching centers (MSC) 108 and 110, associated home location register (HLR) 112 and visitor location registers (VLR) 114 and 116. The function and structure of these conventional GSM architecture elements are known to those in the art and will not be described in further detail here. The core network 104 also supports the General Packet Radio Service (GPRS), and to this end serving GPRS support nodes (SGSN) 118 and 120 are illustrated. Although not illustrated in the figure, it will be understood by those skilled in the art that the core network 104 may include access to other mobile and fixed-line networks, such as ISDN and PSTN networks, packet and circuit switched packet data networks such as intranets, extranets and the Internet through one or more gateway nodes.

The access portion 106 essentially consists of multiple base station subsystems (BSS) 122, only one of which is illustrated. The BSS 122 includes one or more base station controllers (BSC) 124 and one or more base transceiver stations (BTS) 126, 128 and 130. The BSS 122 or BSC 124 communicates via defined fixed standard A and Gb interfaces with MSC 110 and SGSN 120, respectively in the core network portion 104. The BSC 124 communicates with the one or more BTS 126, 128 and 130 via the defined A_{bis} interface. The BTS 130 communicates with mobile stations or terminals (MS or MT 132 over the GSM standard Uₘ radio air interface. Note that the BSC 124 is often separate from the BTSs 126, 128 and 130 and may even be located at the MSC 110. The physical division depicted in FIG. 1 serves to distinguish between the parts of the network making up the access network portion 106 and those that form the core network portion 104.

In addition to the standard access network portion provided by the BSS 122, the network depicted in FIG. 1 further includes an unlicensed-radio access network (UMAN 102). The components making up this UMAN 102 also enable the MS 132 to access the GSM core network 104, and through this, other communication networks via an unlicensed-radio interface X. A used herein, unlicensed-radio means any radio protocol that does not require the operator running the mobile network to have obtained a license from the appropriate regulatory body. In general, such unlicensed-radio technologies must be low power and thus of limited range compared to licensed mobile radio services. This means that the battery lifetime of mobile terminals will be greater. Moreover, because the range is low the unlicensed-radio may be a broadband radio, thus providing improved voice quality. The radio interface may utilize any suitable unlicensed-radio protocol, for example a wireless LAN protocol, Bluetooth radio or Digital Enhanced Cordless Telecommunications (DECT). These radios have higher bandwidth and lower power consumption than conventional public mobile network radio.

These unlicensed-radio standards specify a two-way digital radio link for short-range connections between different devices. Devices are equipped with a transceiver that transmits and receives in one or more frequency bands, such as around 2.45 GHz. The 2.45 GHz band is available globally with some variation of bandwidth depending on the country. Both data and voice channels are available. Each device has a unique 48-bit address from the IEEE 802 standard. Built-in encryption and verification is also available. The element of the UMAN 102 adapted to communicate across the unlicensed-radio interface is designated as an access point (AP) 134, 136, 138 and 140 (also referred to as a local or home base station (HBS)). The AP 134 handles the radio link protocols with MS 132 and contains radio transceivers that define a cell in a similar manner to the operation of a conventional GSM BTS 130. The AP 134 is controlled by a unlicensed network controller (UNC) 142, 144 or 146 (also referred to as a home base station controller (HBSC)), which communicates with MSC 110 over the GSM standard A interface and also with a serving GPRS support node SGSN 120 over a standard Gb interface, if available in the core network 104. The joint function of the AP 134 and the UNC 142 emulates the operation of the BSS 122 towards the SGSN 120 and MSC 110. In other words, when viewed from the elements of the core network 104 such as the MSC 110 and the serving GPRS support node (SGSN) 120, the UMAN 102 constituted by the APs 134, 136, 138 and 140 and the UNC 142 looks like a conventional access network 106.

The interface between the access points 134, etc. and the UNC 142 is preferably provided by a fixed link. The home base station (not shown, but can be integrated in the AP) is intended to be a small device that a subscriber can purchase and install in a desired location such as the home or an office environment to obtain a fixed access to the UMA network. However, they could also be installed by operators in traffic hotspots. In order to reduce the installation costs on the part of the operator, the interface between the home base station (not shown) and the UNC 142 preferably exploits an already existing connection provided by a fixed network 148. Preferably this network 148 is a broadband packet-switched network. Suitable networks might include those based on ADSL, Ethernet, LMDS, or the like. Home connections to such networks are increasingly available to subscribers.

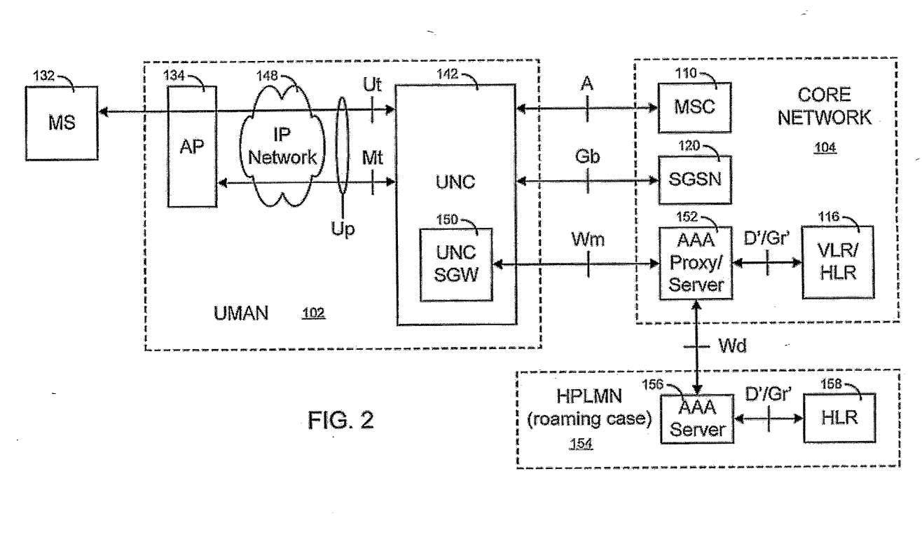

Now referring to FIG. 2, a block diagram of the UMA high level functional architecture is shown. The UMAN 102 includes one or more APs 134 and one or more UNCs 142 (each having a Secure Gateway 150 (UNC SGW)), interconnected through a broadband IP network 148. The UNC SGW 150 terminates secure remote access tunnels from the MS 132 and provides mutual authentication, encryption and data integrity for signaling, voice and data traffic. The UMAN 102 co-exists with the GSM/GPRS radio access network and interconnects to the GSM core network 104 via the same interfaces used by a standard GERAN BSS network element: GSM A-interface for circuit switched services; GPRS Gb-interface for packet services; and Wm-interface or other standard interface for authentication, authorization and accounting. The UNC 142 appears to the GSM/GPRS core network 104 as a GERAN BSS. The principle elements of transaction control (e.g., call processing) and user services are provided by the network elements in the core network 104, namely the MSC 110, SGSN/GGSN 120, Authentication, Authorization and Accounting Proxy/Server 152 (AAA Proxy/Server) and the VLR/HLR 116. The AAA Proxy/Server 152 interfaces with VLR/HLR 116 via D′/Gr′ interface. Whenever the MS 132 is roaming, the GSM/GPRS core network 104 will interface with the MS's Home Public Land Mobile Network 154 (HPLMN). Specifically, AAA Proxy/Server 152 will interface with AAA Server 156 via Wd interface. The AAA Server 156 will interface with HLR 158 via D′/Gr′ interface.

Broadband IP network 148 provides connectivity between the user premises and the UNC 142. An AP 134 in the user premises provides the radio link to the MS 132 using unlicensed spectrum. The IP transport network extends all the way from the UNC 142 to the MS 132, through an AP 134. A single interface, Ut, is defined between the UNC 142 and the MS 132. The Mt interface is an interface between the UNC 142 and the AP 134. This interface may be used for special functions in some realizations. The Ut and Mt interfaces are collectively referred to as the Up interface.

The MS 132 provides dual mode (licensed and unlicensed) radios and the capability to switch between them. The MS 132 supports an IP interface to the AP 134. In other words, the IP network from the UNC 142 extends all the way to the MS 132. The MS 132 is defined for the applicable unlicensed radio, such as Bluetooth (using the Bluetooth PAN profile) and 802.11.

The AP 134 provides the radio link towards the MS 132 using unlicensed spectrum and connects through the broadband IP network 148 to the UNC 142. The AP 134 provides the applicable unlicensed radio profile or access point functions, such as Bluetooth (PAN profile) or 802.11 access point functions. The AP 134 may also use other radio access technologies, such as 802.16 or 802.20, etc. Any “standard” AP can be used to interconnect the MS 132 to the broadband IP network 148.

A UNC 142 connects to a unique MSC 110 and SGSN 120 via the A-interface and Gb interface respectively. This does not preclude support of A-flex and Gb-flex features. The UNC 142 provides functions equivalent to that of a GSM/GPRS BSC. The UNC 142 connects via the IP transport network 148 to the AP 134. The UNC 142 interfaces to the MS 132 using the Ut interface and maintains end-to-end communication with the MS 132 and relays GSM/GPRS signaling to the A/Gb interface towards the core network 104. The UNC 142 performs the following functions: transcoding voice to/from the MS 132 to PCM voice when TFO/TrFO features are not being utilized from/to the MSC 110; and the following Ut functionality: registration for UMA service access; set-up of UMA bearer paths for CS and PS services, including participation in establishment, management, and teardown of secure signaling and user plane bearers between the MS 132 and the UNC 142; UMA equivalent functionality for paging and handovers; and transparent transfer of L3 messages between the MS 132 and core network 104.

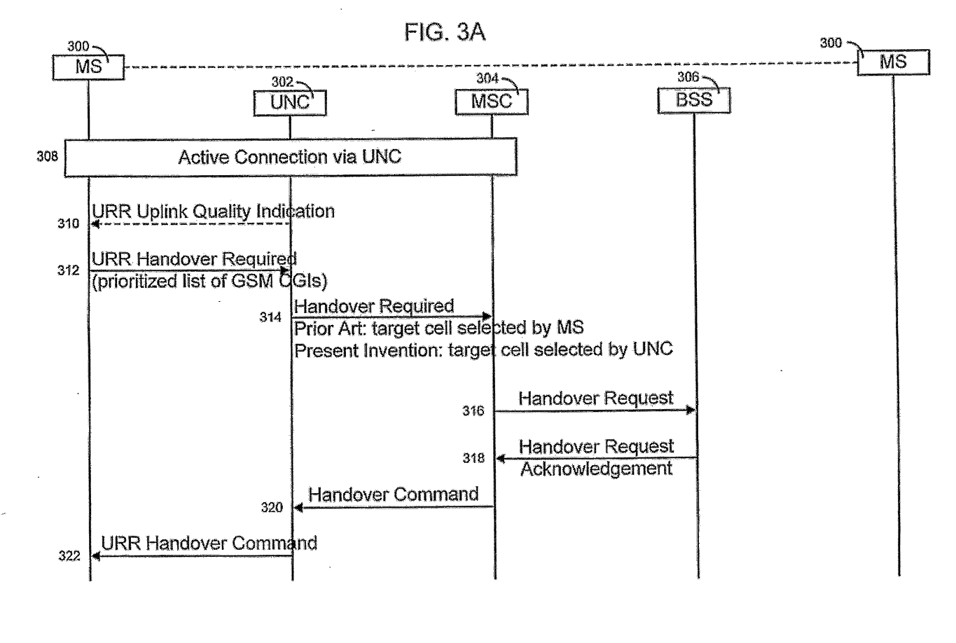

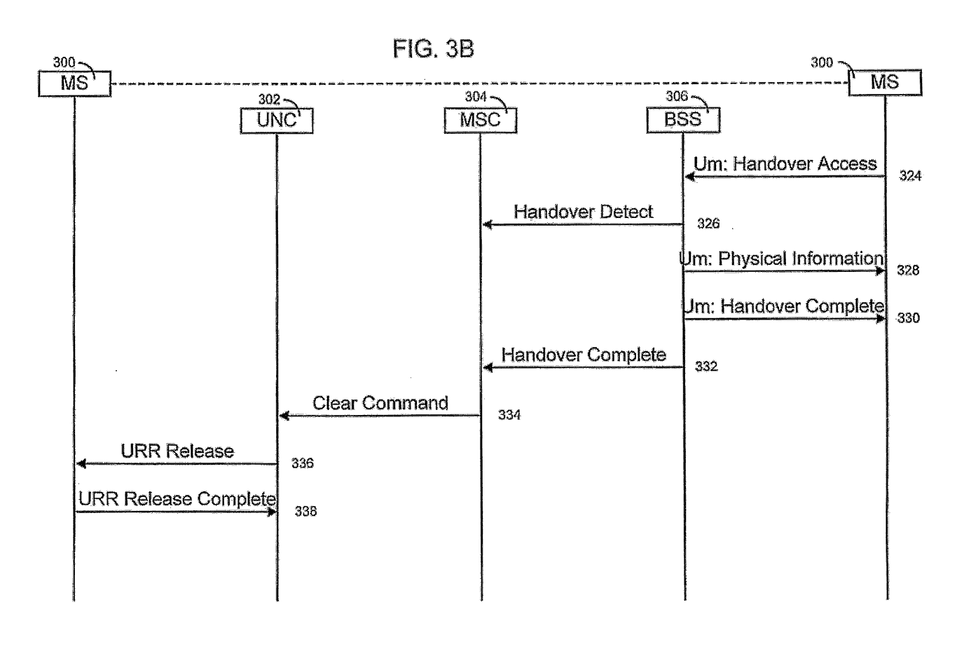

Referring now to FIGS. 3A and 3B, representative signaling sequences for the handover of a MS 300 out of UMAN are shown. As shown, the MS 300 has an active connection 308 via UNC 302. The UNC 302 provides MS 300 with a URR Uplink Quality Indication 310 when needed. As previously described, handover out of UMAN is defined in the Unlicensed Mobile Access (UMA) specifications such that MS 300 makes the decision on when handover out from UMAN should be triggered based on following information:
(1) local measurements of UMA coverage signal quality;
(2) reception of a URR Uplink Quality Indication message from the UNC 302 indicating poor uplink quality;
(3) reception of RTCP packets indicating poor uplink quality; and
(4) excessive loss or delay in the received RTP packets.
   Furthermore, it is the responsibility of the MS 300 to provide one or more Target Cell Identifiers (CGIs) representing Handover Target Cell(s) to the UNC 302. These MS Target Cell Identifiers are provided to the UNC 302 when the MS 300 initiates the handover by sending a URR Handover Required message 312 to the UNC 302. The MS 300 prioritizes these CGI's in the order of preference, meaning that the most suitable GSM cell is included as the first CGI (most suitable as detected and decided by the MS).

When UNC 302 receives this message 312, it sends a Handover Required message 314 to the MSC 304 to initiate the normal A-interface procedures towards the Core network to initiate handover of MS 300 out of the UMAN. Unlike the prior art systems in which the Target Cell was selected by the MS 300, the UNC 302 of the present invention selects the Target Cell that is included in message 314. Note that UNC 302 can initiate handover towards the Core Network using only the CGI with the highest priority and if this fails, then that the second highest priority CGI and initiate handover towards that Cell. Although the whole message sequence for handover out of UMAN is shown in FIGS. 3A and 3B, a detailed explanation is not necessary to understand how the present invention can be incorporated into current handover procedures.

The MSC 304 sends a Handover Request 316 to the BSS 306 for the selected Target Cell. The BSS 306 responds with a Handover Request Acknowledgement message 318. MSC 304 then sends a Handover Command message 320 to UNC 302, which sends a URR Handover Command message 322 to MS 300. The MS 300 then sends an Um Handover Access message 324 to BSS 306, which sends a Handover Detect message 326 to MSC 304 and also sends an Um Physical Information message 328 and Um Handover Complete message 330 to MS 300. BSS 306 also sends a Handover Complete message 332 to MSC 304, which sends a Clear Command message 334 to UNC 302. UNC 302 sends a URR Release message 336 to MS 300, which responds with a URR Release Complete message 338.

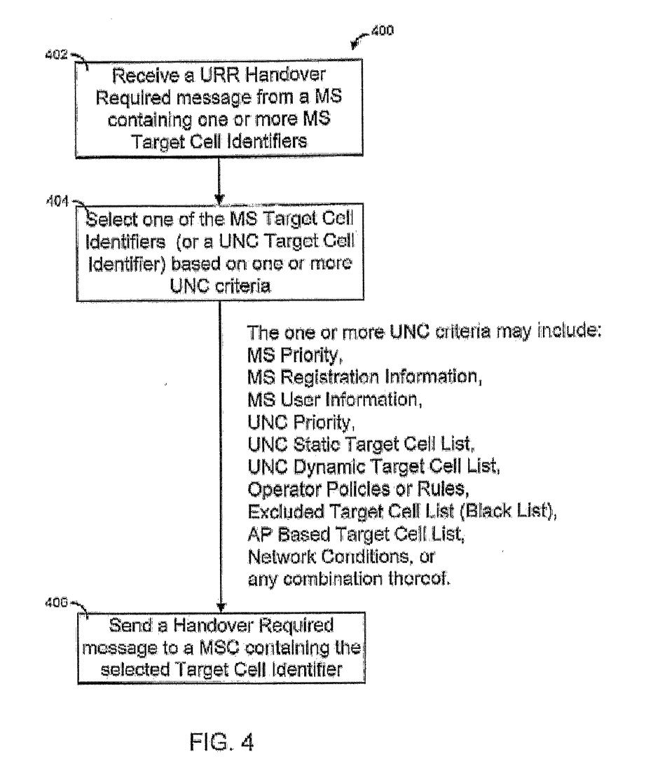

Now referring to FIG. 4, a flow chart depicting the handover 400 of mobile stations (MS) out of unlicensed mobile access networks (UMAN) in accordance with the present invention is shown. The UNC 302 receives a URR Handover Required message 312 from a MS 300 containing one or more MS Target Cell Identifiers (e.g., a prioritized list of GSM CGIs) in block 402. The UNC 302 selects one of the MS Target Cell Identifiers (or a UNC Target Cell Identifier) based on one or more UNC criteria in block 404. The one or more UNC criteria may include MS Priority, MS Registration Information, MS User Information, UNC Priority, UNC Static Target Cell List, UNC Dynamic Target Cell List, Operator Policies or Rules, Excluded Target Cell List (Black List), AP Based Target Cell List, Network Conditions, or any combination thereof. The UNC 302 then sends a Handover Required message 314 to a MSC 304 containing the selected Target Cell Identifier in block 406. As a result, the UMAN operator can devise and implement Target Cell selection criteria that are simple or complex, static or dynamic, manual or automatic, intuitive or adaptive, etc.

The present invention provides an almost countless number of methods for the UNC 302 to select the Target Cell Identifier. In one example, the UNC 302 maintains a list of Handover Target cells for each MS 300 or AP based on, for example, the AP-ID, GSM-CGI or parts of it reported by the MS 300. This means that depending on the information provided by the MS 300 to UNC 302 during registration, the UNC 302 selects the Handover Target Cell instead of relying on the information received by the MS 300. The UMAN operator manages the Handover Target List in the UNC. In another example, the UNC 302 builds the Handover Target List dynamically based on how handovers out from UMAN are succeeding and failing. In yet another example, the previous two examples are combined such that parts of the Handover Target List are maintained manually and parts are created dynamically. The manual part could be, for example, policies or rules on how the dynamic part is built. Note that all methods described herein can be performed by a computer program embodied on a computer readable medium wherein each step is implemented by one or more code segments.

The MS 300 sends the following information (among other information) to the UNC 302 during registration or registration update:
International Mobile Subscriber Identity (IMSI)—Mobile Identity consisting of MCC, MNC and MSIN. MCC and MNC define a PLMN.
GSM Cell Global Identity (GSM CGI)—consisting of Location Area Identification (LAI), which also contains MCC, MNC and LAC, and Cell Identity (CI), which identifies a specific Cell inside one Location area.
AP Radio Identity (AP-ID)—The Radio MAC-address of the AP identifying each AP. The MS 300 reports the AP-ID and UNC 302 can make a database lookup to find the location (longitude, latitude) of the AP. Location of the MS 300 is close enough to the Location of the AP.
GPS coordinates (optional)—The location (longitude, latitude, height) of the MS 300 is reported to the UNC 302.
AP location—AP Location is reported by the MS 300 (e.g., in the format of a street address). UNC 302 can make a database lookup to find the location (longitude, latitude) of the AP.

Location of the MS 300 is close enough to the Location of the AP. The UNC 302 can use this information to filter out the Handover Target CGI List sent by the MS 300, or even to create other CGIs as Handover Target Cell candidates. For example, UNC 302 can select a Handover Target Cell using:
Only the AP-ID: Operator knows the location of the AP and can provisioning the Handover Target Cell based on this information only.
AP-ID and PLMN of the IMSI: UMAN operator is connected to different Core Networks and by using the HPLMN of the IMSI, the UNC 302 can select the most appropriate Handover Target Cell.
AP-ID and GSM-CGI (or parts of it): The UNC 302 can use this information to further select the most appropriate Handover Target Cell.
AP Location: The AP Location can either be reported by the MS 300 or the MS 300 reports the AP-ID and UNC 302 makes a database lookup to find the location (longitude, latitude) of the AP. UNC 302 can select the most appropriate Handover Target Cell based on the Location Information.
Any combination of the information above.
   The UMAN operator may have to maintain a lot of data depending on the selection criteria and techniques used by UNC 302.

In another example, the UNC 302 can be self-learning and build the needed Handover Target Cell lists dynamically. UNC 302 will normally have access to an AP database that can contain location information. This database can be extended to contain a prioritized list of Handover Target Cell for the AP. The basic steps are as follows:
1. UNC 302 maintains AP Handover Target Cell List and initially this list is empty.
2. When the UNC 302 receives a list of Handover Target Cells from the MS 300 (MS Handover Target Cell List), it knows on which AP this MS 300 is using and updates the list. This can be done by also keeping the prioritization information.
3. UNC 302 selects the Handover Target Cell from this AP list and initiates Handover towards the Core Network.
4. If the Handover is successful, then the AP Handover Target Cell List is updated with a credit for that CGI on this AP making it more easily selected.
5. If the Handover fails, then the AP Handover Target Cell List is updated making the used CGI more seldom selected. Depending on the failure cause from the Core Network, the CGI could also be totally deleted or black-listed in the AP Handover Target Cell List.
   One further improvement is to also use global Handover Target Cell Black List in the UNC 302. This means that in the step 5 above, depending on the Failure Cause received from the Core Network, the CGI is put into this list and the UNC 302 shall never initiate Handover out towards that CGI from any AP. The operator can also update the UNC 302 Handover Target Cell Black List manually.

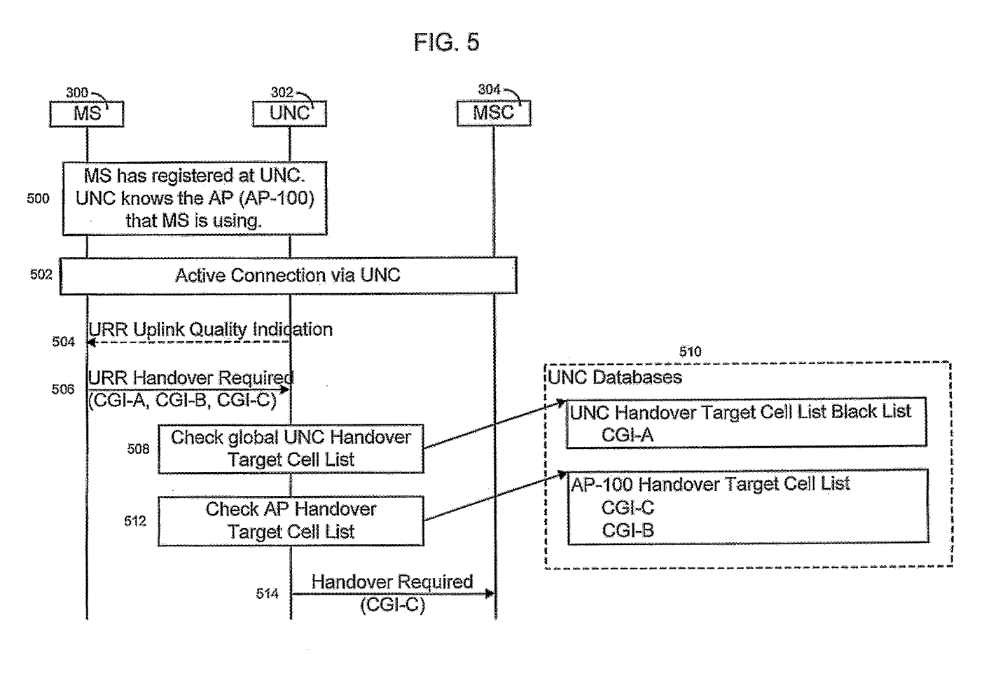

Now referring to FIG. 5, an example of representative signaling sequences using a handover procedure in accordance with one embodiment of the present invention is shown. In this example, the UNC 302 is updated by either self-learning or manually for one AP and the UNC Handover Target Cell Black List has also been updated earlier. UNC Handover Target Cell Black List and AP-100 Handover Target Cell List are stored in UNC Databases 510. Note that this is only one way to maintain and use the databases in the UNC.

The MS 300 has registered at the UNC 302 and has included information about the current AP being used (AP-100) in block 500. In addition, the MS 300 has established an active connection 502 (e.g. a voice call) through the UNC 302 and MSC 304. MS 300 decides that it is time to trigger handover out from UMAN. One trigger point can be the receiving of URR Uplink Quality Indication message 504 from the UNC 302. MS 300 sends the URR Handover Required message 506 to the UNC 302 and this message contains three CGIs (CGI-A, CGI-B and CGI-C) as Handover Target Cells. These three CGIs are used to build the initial Handover Target Cell candidate list in the UNC 302.

As shown in block 508, the UNC 302 checks the global UNC Handover Target Cell Black List and finds out that the CGI-A is a forbidden Handover Target Cell, so CGI-A is removed from the Handover Target Cell candidate list. Next, as shown in block 512, the UNC 302 checks the AP specific Handover Target Cell List and finds out that the CGI-C is the preferred Handover Target Cell for this AP and the new Handover Target Cell candidate list is now: CGI-C, CGI-B. UNC 302 initiates handover towards the Target Cell CGI-C using Handover Required message 514 and UNC 302 also remembers the CGI-B, if the Handover towards CGI-C would fail. Another option for the UNC 302 would be to include both CGI-C and CGI-B in the first message 514 sent to the MSC 304.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method handover of a mobile station (MS) out of an unlicensed mobile access network (UMAN), the method comprising the steps of:
receiving a URR Handover Required message containing one or more MS Target Cell Identifiers from the mobile station at an unlicensed mobile access network controller (UNC);
selecting one of the MS Target Cell Identifiers based on one or more UNC criteria; and
sending a Handover Required message containing the selected Target Cell Identifier.

2. The method as claimed in claim 1, further comprising the step of sending a second Handover Required message containing a next selected Target Cell Identifier whenever the handover fails.

3. The method as claimed in claim 1, wherein the MS Target Cell Identifiers comprise a prioritized list of GSM CGIs.

4. The method as claimed in claim 1, wherein a UNC Target Cell Identifier is selected instead of one of the MS Target Cell Identifiers.

5. The method as claimed in claim 1, wherein the one or more UNC criteria comprise MS Priority, MS Registration Information, MS User Information. UNC Priority, UNC Static Target Cell List, UNC Dynamic Target Cell List, Operator Policies or Rules, Excluded Target Cell List (Black List), AP Based Target Cell List, Network Conditions, or any combination thereof.

6. The method as claimed in claim 1, wherein the one or more UNC criteria comprises one or more UNC maintained Handover Target Cell Lists.

7. The method as claimed in claim 1, wherein the one or more UNC criteria comprise a UNC maintained Handover Target Cell List for each MS or AP based on information provided by the MS to the UNC during registration.

8. The method as claimed in claim 1, wherein the one or more UNC criteria comprise a UNC maintained Handover Target Cell List that is dynamically based on how handovers out from UMAN are succeeding or failing.

9. A computer program embodied on a computer readable medium for handover of a mobile station (MS) out of an unlicensed mobile access network (UMAN), the computer program comprising:
a code segment for receiving a URR Handover Required message containing one or more M:3 Target Cell Identifiers from the mobile station at an unlicensed mobile access network controller (UNC);
a code segment selecting one of the MS Target Cell Identifiers based on one or more UNC criteria; and
a code segment sending a Handover Required message containing the selected Target Cell Identifier.

10. The computer program as claimed in claim 9, further comprising a code segment for sending a second Handover Required message containing a next selected Target Cell Identifier whenever the handover fails.

11. The computer program as claimed in claim 9, wherein the MS Target Cell Identifiers comprise a prioritized list of GSM CGIs.

12. The computer program as claimed in claim 9, wherein a UNC Target Cell Identifier is selected instead of one of the MS Target Cell Identifiers.

13. The computer program as claimed in claim 9, wherein the one or more UNC criteria comprise MS Priority, MS Registration Information, MS User Information, UNC Priority, UNC Static Target Cell List, UNC Dynamic Target Cell List, Operator Policies or Rules, Excluded Target Cell List (Black List), AP Based Target Cell List, Network Conditions, or any combination thereof.

14. The computer program as claimed in claim 9, wherein the one or more UNC criteria comprises one or more UNC maintained Handover Target Cell Lists.

15. The computer program as claimed in claim 9, wherein the one or more UNC criteria comprise a UNC maintained Handover Target Cell List for each MS or AP based on information provided by the MS to the UNC during registration.

16. The computer program as claimed in claim 9, wherein the one or more UNC criteria comprise a UNC maintained Handover Target Cell List that is dynamically based on how handovers out from UMAN are succeeding or failing.

17. A system in an unlicensed mobile access network (UMAN) comprising:
a mobile station (MS);
an unlicensed mobile access network controller (UNC) in communication with the MS; and
one or more UNC databases accessible by the UNC and containing one or more UNC criteria used to select a Target Cell Identifier for a handover of the MS out of the UMAN whenever a URR Handover Required message containing one or more MS Target Cell Identifiers is received from the mobile station at the unlicensed mobile access network controller.

18. The system as claimed in claim 17, wherein the one or more UNC criteria comprise MS Priority, MS Registration Information, MS User Information, UNC Priority, UNC Static Target Cell List, UNC Dynamic Target Cell List, Operator Policies or Rules, Excluded Target Cell List (Black List). AP Based Target Cell List. Network Conditions, or any combination thereof.

19. The system as claimed in claim 17, wherein the one or more UNC criteria comprises one or more UNC maintained Handover Target Cell Lists.

20. The system as claimed in claim 17, wherein the one or more UNC criteria comprise a UNC maintained Handover Target Cell List for each MS or AP based on information provided by the MS to the UNC during registration.

21. The system as claimed in claim 17, wherein the one or more UNC criteria comprise a UNC maintained Handover Target Cell List that is dynamically based on how handovers out from UMAN are succeeding or failing.
